(19) United States
(12) Patent Application Publication
(10) Pub. No.: US 2015/0346375 A1
(43) Pub. Date: Dec. 3, 2015

(54) Application-Specific Integrated Circuits for Downhole Applications

(71) Applicant: SCHLUMBERGER TECHNOLOGY DRIVE, Sugar Land, TX (US)

(72) Inventor: Patrick Vessereau, Hericy (FR)

(21) Appl. No.: 14/759,192

(22) PCT Filed: Jan. 10, 2014
(86) PCT No.: PCT/US14/10982

§ 371 Date: Jul. 2, 2015

Related U.S. Application Data
(60) Provisional application No. 61/750,846, filed on Jan. 10, 2013.

(51) Int. Cl. G01V 3/20; E21B 47/12; E21B 49/00; E21B 47/00

(52) U.S. Cl. CPC G01V 3/20; E21B 47/0002; E21B 47/12; E21B 49/00

(57) ABSTRACT

A downhole imaging tool operable to obtain measurement data associated with a subterranean formation at a frequency above about 100 kHz. An application-specific integrated circuit (ASIC) is conveyable with the downhole imaging tool and operable to perform at least one of data acquisition, signal processing, and signal transmission utilizing the measurement data obtained by the downhole imaging tool.

### CROSS-REFERENCE TO RELATED APPLICATIONS

This application claims the benefit of U.S. Provisional Application No. 61/750,846, entitled “ASIC Concept for a Downhole Tool,” filed Jan. 10, 2013, the entire disclosure of which is hereby incorporated herein by reference.

### BACKGROUND OF THE DISCLOSURE

Various downhole tools exist for determining properties of geological formations surrounding wells. For example, a resistivity or similar downhole tool may inject an electrical current into a formation via an injection electrode, and the current may return to the downhole tool from the formation via a return electrode. One or both of the injection and return electrodes may be operable to measure current. The resistivity tool may be utilized in the determination of impedance, resistivity, and/or other characteristic of the formation, where such determination may utilize differences between the injected and returning currents measured by the downhole tool. For example, different types and/or regions of geological formations have different resistivity, impedance, and/or other electrical characteristics, such that their determination may provide an indication of the composition and/or other properties of the geological formation.

In some implementations, such measurements may be utilized to generate or otherwise obtain an image of the geological formation. However, downhole formations may have relatively low resistivity, which may be difficult to measure, and which may therefore result in low-resolution images. Thus, in an attempt to increase sensitivity to formation resistivity and/or other electrical characteristics, downhole tools may be operated at higher frequencies. However, the downhole tools utilizing increased operating frequencies also exhibit increased complexity and costs associated with manufacturing and operations.

### SUMMARY OF THE DISCLOSURE

The present disclosure introduces an apparatus comprising a downhole imaging tool conveyable within a wellbore to a position proximate a subterranean formation penetrated by the wellbore. The downhole imaging tool is operable to obtain measurement data associated with the subterranean formation, wherein such operation is at a frequency above about 100 kHz. The apparatus also includes an application-specific integrated circuit (ASIC) conveyable within the wellbore with the downhole imaging tool and operable to perform at least one of data acquisition, signal processing, and signal transmission utilizing the measurement data obtained by the downhole imaging tool.

The present disclosure also introduces a method comprising operating a downhole tool to measure a property of a subterranean formation and determine at least one of impedance and resistivity of a portion of the subterranean formation. A first application-specific integrated circuit (ASIC) of the downhole tool may be operated to acquire a signal related to the measurement. A second ASIC of the downhole tool may be operated to process the signal.

The present disclosure also introduces an apparatus comprising a downhole system including a downhole tool conveyable within a wellbore extending into a subterranean formation. The downhole tool includes an application-specific integrated circuit (ASIC) device having a first ASIC operable to acquire data from a component outside of the ASIC device. The ASIC device also includes a second ASIC operable to receive data acquired by the first ASIC, perform data processing utilizing the received data, and transmit a signal indicative of results of the data processing to a component of the downhole system that is not part of the ASIC device. The ASIC device also includes a third ASIC operable to control the transmission of the signal to the component.

Additional aspects of the present disclosure are set forth in the description that follows, and/or may be learned by a person having ordinary skill in the art by reading the materials herein and/or practicing the principles described herein. At least some aspects of the present disclosure may be achieved via means recited in the attached claims.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of apparatus according to one or more aspects of the present disclosure.

FIG. 2 is a block diagram of at least a portion of apparatus according to one or more aspects of the present disclosure.

FIG. 3 is a circuit diagram of at least a portion of apparatus according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

One or more aspects of the present disclosure relate to utilizing an application-specific integrated circuit (ASIC) as, as part of, or otherwise in conjunction with the design and/or other aspects of a high-performance processor in highly-integrated electronic devices operated in high temperature, high pressure, and/or high shock environments.

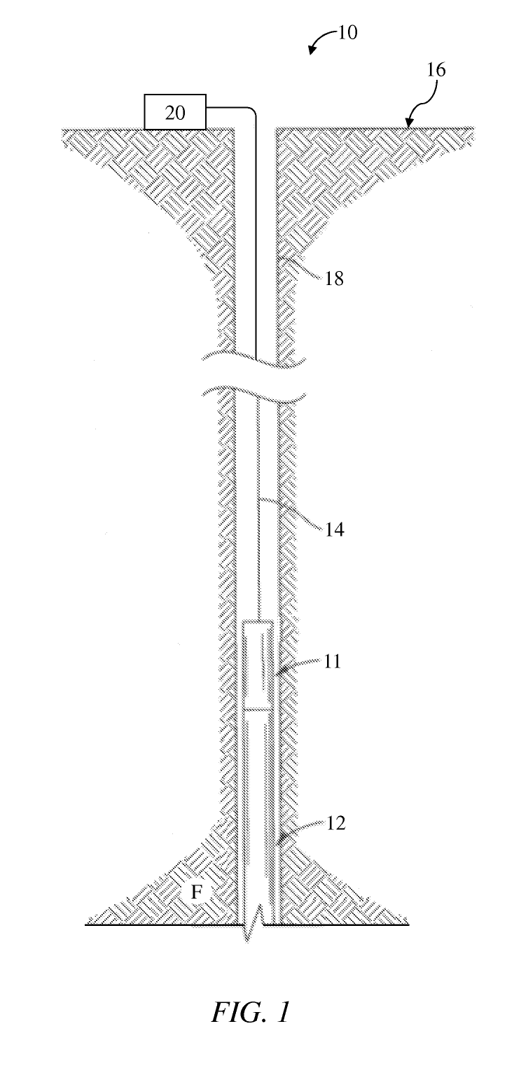

FIG. 1 is a schematic view of a downhole system 10 having a cable head 11 connected at its lower end to a logging tool 12. An upper end of the cable head 11 is secured to a conveyance 14, such as may comprise a wireline, slickline, and/or various types of tubing. The conveyance 14 extends to the surface 16 of a wellbore 18 and is operable to position the cable head 11 and one or more logging tools, such as logging tool 12, with respect to an area where formations and parameters may be determined and/or recorded during logging operations. The wellbore 18 is depicted in FIG. 1 as being substantially vertical, but it may also be highly deviated or even horizontal. During a logging operation, data may be transmitted from the logging tool 12 to the conveyance 14 through the cable head 11. Within the conveyance 14, the data may be transmitted to a data-transmission and acquisition system 20 at the surface 16.

While FIG. 1 depicts the conveyance 14 as a wireline cable, the downhole system 10 of the present disclosure may include drilling or logging systems, such as measurement-while-drilling (MWD) systems, logging-while-drilling (LWD) systems, wireline systems, coiled tubing systems, testing systems, completions systems, productions systems, or combinations thereof Furthermore, the logging tool 12 may be or comprise one or more known and/or future-developed downhole tools operable in the downhole system 10.

For example, the logging tool 12 may be or comprise a downhole imaging tool operable to obtain an image of the formation F surrounding the wellbore 18, such as by obtaining resistivity or micro-resistivity measurements. Such downhole imaging tool may measure the resistivity of the formation F by injecting a current into the surrounding formation F using an injection electrode. The current may return to the tool from the surrounding formation F via a return electrode. One or both of the injection electrode and the return electrode may represent a current-measuring electrode through which the injected and returning currents may be measured. By comparing the injected and returning currents, the resistivity and/or impedance of the surrounding formation F may be determined. The measured resistivity and/or impedance may subsequently be utilized to obtain an image of the formation F surrounding the wellbore 18.

To obtain resistivity measurements from different types of formations, a resistivity tool may operate at relatively high frequencies, such as above about 100 kHz. Acquiring resistivity data in a high-frequency downhole imaging tool may entail acquiring and processing large amounts of data. Accordingly, the present disclosure introduces one or more aspects related to systems, methods, processes, and/or apparatus utilizing integrated circuitry in a high-frequency downhole imaging tool, such as one or more instances of the logging tool 12 shown in FIG. 1.

In the context of the present disclosure, integrated circuitry may include an application-specific integrated circuit (“ASIC”) and/or a combination of processors, microprocessors, and/or memory blocks designed for signal acquisition, data processing, and/or signal output from a downhole apparatus and/or system, such as the downhole system 10 and/or the logging tool 12 shown in FIG. 1. Integrated circuitry may be operable to acquire local measurements and/or signals present in the downhole system 10 and/or logging tool 12. Integrated circuitry may be operable to perform, assist with, and/or contribute to data processing, such as sensor signal conditioning, including various analog functions, algorithms, mathematical functions, and/or signal compression with various size reduction factors, among other examples. Integrated circuitry may provide transmission of digitized and/or the processed signals to other apparatus and/or systems, utilizing various types of transmission channels and/or other means. Integrated circuitry may provide signal digitization with relatively high resolution.

As described above, the logging tool 12 and/or other downhole components of the downhole system 10 may be operable to measure parameters related to the downhole system 10 and/or one or more formations F. Moreover, logging tool 12 and/or other downhole components of the downhole system 10 may include one or more ASIC devices and/or assemblies individually and/or collectively operable to provide, perform, assist with, and/or contribute to high performance acquisition and/or processing. The one or more ASIC devices and/or assemblies may be located in various locations with the logging tool 12 and/or other components of the downhole system 10.

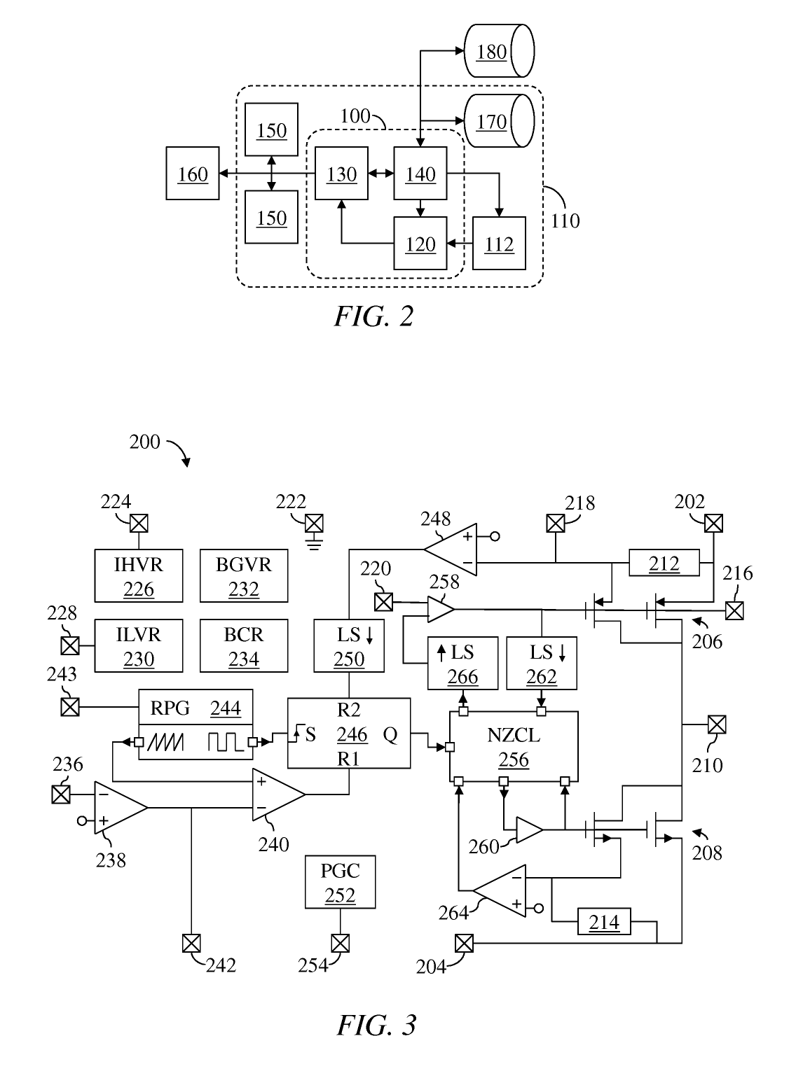

FIG. 2 is a block diagram of at least a portion of an example implementation of one such ASIC device 100 according to one or more aspects of the present disclosure. The ASIC device 100 may be operable to perform signal processing and/or transmission in a downhole system 110. The downhole system 110 may be, or be similar to, or otherwise have one or more aspects in common with the downhole system 10 shown in FIG. 1. The arrows in FIG. 2 may be considered to indicate the transmission direction of data and/or control signals between components of the ASIC device 100, the downhole system 110, and/or other components.

The ASIC device 100 includes an ASIC 120 operable to acquire measurements and/or data from components outside of the ASIC device 100, such as data measured by one or more downhole tools 112 in the system 110. One or more of the downhole tools 112 may be, or be similar to, or otherwise have one or more aspects in common with the logging tool 12 shown in FIG. 1.

The ASIC device 100 also includes an ASIC 130 operable to receive data acquired by the ASIC 120 and perform data processing utilizing the received data. The ASIC 130 may also be operable to transmit signals indicative of the received data, and/or results of the data processing, to one or more components 150 of the downhole system 110 that are not part of the ASIC device 100, and perhaps to one or more components 160 that are outside of the downhole system 110.

However, the ASIC device 100 may also include an ASIC 140 operable to control the transmission of such signals to the components 150 and/or 160, instead of such transmission being controlled by the ASIC 130. Thus, the ASIC 120 may be operable to acquire data from the one or more downhole tools 112, and the ASIC 130 may be operable to process the acquired data and transmit signals indicative of or otherwise related to the acquired and/or processed data, whereas the ASIC 140 may be operable to control such signal transmission by the ASIC 130. Moreover, in implementations that include the ASIC 140, the ASIC 140 may be further operable to control outright the transmission of signals to and from each of the ASICs 120, 130, and 140. The ASIC 140 may also be operable to control other operations of one or both of the ASIC 120 and the ASOC 130. Thus, the ASIC 120 may be or be operable as a signal acquisition ASIC, the ASIC 130 may be or be operable as a communication ASIC, and the ASIC 140 may be or be operable as a signal and/or processor master control ASIC.

The ASIC 140 may be further operable to exchange data with direct access and/or other storage 170 within the downhole system 110, and/or with direct access and/or other storage 180 outside the downhole system 110. Such exchange may be to retrieve data from the storage 170 and/or 180, or to write data to the storage 170 and/or 180. One, two, or each of the ASICs 120, 130, and 140 may perform outright the data processing collectively performed within the ASIC device 100.

FIG. 3 is a circuit diagram of an example implementation of an ASIC 200 according to one or more aspects of the present disclosure. One, two, or each of the ASICs 120, 130, and 140 shown in FIG. 2 may be, or be similar to, or otherwise have one or more aspects in common with the ASIC 200 shown in FIG. 3. For example, the ASIC 200 may include circuitry operable to perform or assist in the data acquisition, data processing, and/or signal transmission described above with respect to FIG. 2. Example operations that may be performed by the ASIC 200 may include amplifying, filtering, phase-shifting, processing, transmitting, and outputting, among others. For example, the ASIC 200 may be operable to perform or assist in the performance of acquiring, processing, and/or transmitting high-frequency data and/or signals acquired, processed, and/or transmitted by a high-frequency downhole imaging tool, such as the downhole tool 112 shown in FIG. 2 and/or the logging tool 12 shown in FIG. 1.

The ASIC 200 depicted in FIG. 3 includes an input-voltage connection (VIN) 202, which may be connected to one or various input voltage sources, such as one or more batteries and/or other direct current (DC) voltage sources. The ASIC 200 also includes a ground connection (GND) 204.

Between the VIN 202 and GND 204 connections are two switches 206 and 208. One switch 206 may be or comprise a p-channel device, and the other switch 208 may be or comprise an n-channel device, or the switches 206 and 208 may otherwise have opposite channel functions.

The ASIC 200 also includes an output connection (OUT) 210, which may supply the power-switched output of the ASIC 200, such as may be connected to an inductor-capacitor filter (not shown) to provide a DC output voltage. Thus, for example, when the switch 206 is closed, then the output signal at OUT 210 may be pulled up to the input-voltage at YIN 202, and when the switch 208 is closed, then the output signal at OUT 210 may be pulled down to ground at GND 204. By alternating the switches 206 and 208, an averaged signal that may be achieved at OUT 210 may, when run through the inductor-capacitor filter described above, for example, result in an output voltage that is controllable by varying the duty cycle of the switches 206 and 208. Thus, the ASIC 200 may generate a voltage at OUT 210 that is switched between VIN 202 and GND 204, such as to supply a controllable output voltage (e.g., about 5 volts).

The ASIC 200 also includes a number of other devices that aid in the control of the switches 206 and 208. For example, resistors and/or resistive devices 212 and 214 may be utilized in the measurement of current through the switches 206 and 208. Other examples may include a switched output voltage connection (SW) 216, an over-voltage control connection (OVC) 218, and on or more selector connections (SEL) 220. The ASIC 200 may also comprise an additional connection 222 to Earth or ground (E).

Various devices within the ASIC 200 may operate based on reference voltages and/or currents other than those at VIN 202 and/or GND 204. Thus, for example, the ASIC 200 may also comprise a reference high-voltage connection (FHV) 224 utilized by an internal high voltage regulator 226, a reference low-voltage connection (FLV) 228 utilized by an internal low voltage regulator 230, a bandgap voltage reference 232, and/or a bias current reference 234. One or more of these references may also be utilized to turn one or more of the regulators on and/or off.

The ASIC 200 also includes a feedback connection (FB) 236 that may be utilized by an error amplifier (EA) 238. For example, one or more conductive elements (not shown) may connect the output at OUT 210 to FB 236, which may be utilized by EA 238 in conjunction with a reference voltage (e.g., about 1 V). The result may be utilized by a pulse width modulator comparator (PWMC) 240. A comparator connection (CMP) 242 may be utilized to bring this signal out of the ASIC 200 and/or to provide an additional input for the PWMC 240.

The ASIC 200 also includes a frequency input connection (FC) 243, which may be utilized as a frequency input to a ramp/pulse generator (RPG) 244. For inputs, the PWMC 240 utilizes an output of the RPG 244 and at least one of the output of the EA 238 and an input via CMP 242. The output of the PWMC 240 is connected to a “reset” terminal (R1) of a flip-flop device 246. An over-current detection comparator (OCDC) 248 may be connected to another “reset” terminal (R2) of the flip-flop device 246. The output of the OCDC 248 may be the comparison result of the OVC 218 and a reference voltage (REFP) related to the switch 206. A level shift 250 may be operative between the OCDC 248 and the flip-flop device 246. Another output of the RPG 244 may be connected to a “set” terminal of the flip-flop device 246. Thus, the flip-flop device 246 may operate as or provide a pulse width control or control signal that regulates pulse width for the switches 206 and 208 leading to OUT 210. That is, by regulating the pulse width via a feedback node (utilizing FB 236, EA 238, etc.), the output voltage at OUT 210 can be controlled.

The ASIC 200 may also comprise a “power good” comparator (PGC) 252, which may be connected to a power connection (PG) 254. The PGC 252 and/or PG 254 may be utilized as or with an alarm or monitor that may indicate proper or improper operation.

The ASIC 200 may also include non-overlap and zero-current detection (ZCD) control logic (NZCL) 256, a driver 258 leading to the switch 206, and another driver 260 leading to the switch 208. The NZCL 256 may aid in ensuring that the switches 206 and 208 are not turned on at the same time, such that one is turned off before the other is turned on. Otherwise, an electrical short may be established between VIN 202 and GND 204. Inputs to the NZCL 256 may include the output (Q) of the flip-flop device 246 (e.g., “high” or “low”), output of the driver 258 (perhaps through a level shift 262), output of the driver 260, and output of a zero-current detection comparator (ZCDC) 264. Inputs for the ZCDC 264 may include output from the switch 208 and a reference voltage (REFN) related to the switch 208.

Inputs for the driver 258 may include SEL 220 and an output from the NZCL 256, perhaps through a level shift 266. Input for the driver 260 may be another output from the NZCL 256. The drivers 258 and 260 may be included because a substantial amount of pulse current may be utilized to turn the gates of the switches 206 and 208.

The OCDC 248, the NZCL 256, and the ZCDC 264 may be utilized to ensure that current does not “shoot through” from VIN 202 to GND 204. For example, these components may individually or in combination ensure that no current exists before turning on the ASIC 200, and/or to ensure that the existing current is not excessive.

In view of the entirety of the present disclosure, including FIGS. 1-3, a person having ordinary skill in the art will recognize that the present disclosure introduces an apparatus comprising: a downhole imaging tool conveyable within a wellbore to a position proximate a subterranean formation penetrated by the wellbore, wherein the downhole imaging tool is operable to obtain measurement data associated with the subterranean formation, and wherein such operation to obtain the measurement data is at a frequency above about 100 kHz; and an application-specific integrated circuit (ASIC) conveyable within the wellbore with the downhole imaging tool and operable to perform at least one of data acquisition, signal processing, and signal transmission utilizing the measurement data obtained by the downhole imaging tool.

The ASIC may be a first ASIC, and the apparatus may further comprise a plurality of additional ASICs each conveyable within the wellbore with the downhole imaging tool and operable at the frequency, wherein the downhole imaging tool may comprise one of the additional ASICs.

The ASIC may be a first ASIC conveyable within the wellbore with the downhole imaging tool and operable to acquire the measurement data from the downhole imaging tool. Such apparatus may further comprise a second ASIC conveyable within the wellbore with the downhole imaging tool and operable to process the data acquired by the first ASIC. Such apparatus may further comprise a third ASIC conveyable within the wellbore with the downhole imaging tool and operable to transmit data out of the downhole imaging tool. The apparatus may form at least a portion of a downhole system, and the third ASIC may be operable to transmit data out of the downhole system.

The present disclosure also introduces a method comprising: operating a downhole tool to measure a property of a subterranean formation and determine at least one of impedance and resistivity of a portion of the subterranean formation; operating a first application-specific integrated circuit (ASIC) of the downhole tool to acquire a signal related to the measurement; and operating a second ASIC of the downhole tool to process the signal.

The downhole tool may comprise a resistivity tool having an operational frequency not less than about 100 kHz.

The downhole tool may comprise first and second portions, wherein the first portion may be operable to measure the property of the subterranean formation, and wherein the second portions may comprise the first and second ASICs. The first or second portion or the second ASIC may be operable to determine the at least one of impedance and resistivity of the subterranean formation portion.

The first and second ASICs may be coupled to the downhole tool in a downhole system comprising the downhole tool.

The method may further comprise operating a third ASIC of the downhole tool to transmit the processed signal, perhaps to out of the downhole tool or a downhole system comprising the downhole tool.

The present disclosure also introduces an apparatus comprising: a downhole system comprising: a downhole tool conveyable within a wellbore extending into a subterranean formation, wherein the downhole tool comprises: an application-specific integrated circuit (ASIC) device comprising: a first ASIC operable to acquire data from a component outside of the ASIC device; a second ASIC operable to receive data acquired by the first ASIC, perform data processing utilizing the received data, and transmit a signal indicative of results of the data processing to a component of the downhole system that is not part of the ASIC device; and a third ASIC operable to control the transmission of the signal to the component. The third ASIC may be further operable to outright control signal transmissions to and from each of the first, second, and third ASICs. The data acquired by the first ASIC may relate to measurements of the subterranean formation made by the downhole tool. The second ASIC may be operable to transmit the signal out of the downhole system under the control of the third ASIC.

The foregoing outlines features of several implementations so that a person having ordinary skill in the art may better understand the aspects of the present disclosure. A person having ordinary skill in the art should appreciate that they may readily use the present disclosure as a basis for designing or modifying other processes and structures for carrying out the same purposes and/or achieving the same advantages of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

what is claimed is:

1. An apparatus, comprising:
a downhole imaging tool conveyable within a wellbore to a position proximate a subterranean formation penetrated by the wellbore, wherein the downhole imaging tool is operable to obtain measurement data associated with the subterranean formation, and wherein such operation to obtain the measurement data is at a frequency above about 100 kHz; and
an application-specific integrated circuit (ASIC) conveyable within the wellbore with the downhole imaging tool and operable to perform at least one of data acquisition, signal processing, and signal transmission utilizing the measurement data obtained by the downhole imaging tool.

2. The apparatus of claim 1 wherein the ASIC is a first ASIC, the apparatus further comprises a plurality of additional ASICs each conveyable within the wellbore with the downhole imaging tool and operable at the frequency, and the downhole imaging tool comprises one of the additional ASICs.

3. The apparatus of claim 1 wherein the ASIC is a first ASIC conveyable within the wellbore with the downhole imaging tool and operable to acquire the measurement data from the downhole imaging tool.

4. The apparatus of claim 3 further comprising a second ASIC conveyable within the wellbore with the downhole imaging tool and operable to process the data acquired by the first ASIC.

5. The apparatus of claim 4 further comprising a third ASIC conveyable within the wellbore with the downhole imaging tool and operable to transmit data out of the downhole imaging tool.

6. The apparatus of claim 5 wherein the apparatus forms at least a portion of a downhole system, and wherein the third ASIC is operable to transmit data out of the downhole system.

7. The apparatus of claim 1 wherein the apparatus forms at least a portion of a downhole system, and the apparatus further comprises a third ASIC conveyable within the wellbore with the downhole imaging tool and operable to transmit data out of the downhole system.

8. A method, comprising:
operating a downhole tool to measure a property of a subterranean formation and determine at least one of impedance and resistivity of a portion of the subterranean formation;
operating a first application-specific integrated circuit (ASIC) of the downhole tool to acquire a signal related to the measurement; and
operating a second ASIC of the downhole tool to process the signal.

9. The method of claim 8 wherein the downhole tool comprises a resistivity tool having an operational frequency not less than about 100 kHz.

10. The method of claim 8 wherein the downhole tool comprises first and second portions, wherein the first portion is operable to measure the property of the subterranean formation, and wherein the second portions comprises the first and second ASICs.

11. The method of claim 10 wherein the first portion is operable to determine the at least one of impedance and resistivity of the subterranean formation portion.

12. The method of claim 10 wherein the second portion is operable to determine the at least one of impedance and resistivity of the subterranean formation portion.

13. The method of claim 12 wherein the second ASIC is operable to determine the at least one of impedance and resistivity of the subterranean formation portion.

14. The method of claim 8 wherein the first and second ASICs are coupled to the downhole tool in a downhole system comprising the downhole tool.

15. The method of claim 8 further comprising operating a third ASIC of the downhole tool to transmit the processed signal.

16. The method of claim 8 further comprising operating a third ASIC of the downhole tool to transmit the processed signal out of the downhole tool.

17. The method of claim 8 further comprising operating a third ASIC of the downhole tool to transmit the processed signal out of a downhole system comprising the downhole tool.

18. An apparatus, comprising:
a downhole system comprising:
a downhole tool conveyable within a wellbore extending into a subterranean formation, wherein the downhole tool comprises:
an application-specific integrated circuit (ASIC) device comprising:
a first ASIC operable to acquire data from a component outside of the ASIC device;
a second ASIC operable to receive data acquired by the first ASIC, perform data processing utilizing the received data, and transmit a signal indicative of results of the data processing to a component of the downhole system that is not part of the ASIC device; and
a third ASIC operable to control the transmission of the signal to the component.

19. The apparatus of claim 18 wherein the third ASIC is further operable to outright control signal transmissions to and from each of the first, second, and third ASICs.

20. The apparatus of claim 19 wherein the data acquired by the first ASIC relates to measurements of the subterranean formation made by the downhole tool, and wherein the second ASIC is operable to transmit the signal out of the downhole system under the control of the third ASIC.
